(19) United States
(12) Patent Application Publication
(10) Pub. No.: US 2002/0181542 A1
(43) Pub. Date: Dec. 5, 2002

(54) Spoon with temperature display

(76) Inventor: Chih-Hsiung Lee, Pan-Chiao City (TW)

Correspondence Address: SUPREME PATENT SERVICES, POST OFFICE BOX 2339, SARATOGA, CA, 95070, US

(21) Appl. No.: 09/875,706

(22) Filed: Jun. 5, 2001

(51) Int. Cl. G01K 1/14; G01K 13/00

(52) U.S. Cl. 374/141; 374/157

(57) ABSTRACT

A spoon with temperature display comprises a spoon body, a thermistor, a lead wire, a temperature detector, a temperature display, a cell, and a cell cover. When a user holds a spoon of this invention for filling food, the impedance of the thermistor is changed because heat is conducted from the food to the spoon bowl. Temperature of the food is then detected and converted by the temperature detector into digits and shown in a temperature display panel to keep the user informed of the food's temperature for prevention of scald.

### FIELD OF THE INVENTION

This invention relates to the spoon structure, particularly to a safety spoon with temperature display, wherein a thermistor is buried in the bowl and connected with a temperature detector fitted in the spoon handle via a conductive wire so that the impedance variation of the thermistor can be digitized and shown in a temperature display panel.

### BACKGROUND OF THE INVENTION

It is commonly taken a matter of course that a spoon won't meanwhile considerately tell the temperature of the food when digging on, just like some other trivial matters unworthy of paying any attention in daily life.

However, people, especially children, are occasionally heard injured in taking a scalding soup, particularly when the soup is shielded by an oily membrane that may mislead people to ignore the real temperature of the soup.

For security purpose, there should be some devices or measures that can be taken to prevent dangers, and this invention is just a feasible and effective one.

### SUMMARY OF THE INVENTION

The primary object of this invention is to provide a spoon with temperature display, which can show the temperature of soup or food to be taken so as to prevent people from being scalded.

In order to realize abovesaid object, a spoon of this invention comprises a spoon body, a thermistor, a lead wire, a temperature detector, a temperature display, a cell, and a cell cover. When a user holds a spoon of this invention for filling food, the impedance of the thermistor is changed because heat is conducted from the food to the spoon bowl. Temperature of the food is then detected and converted by the temperature detector into digits and shown in a temperature display panel to keep the user informed of the food's temperature.

For more detailed information regarding advantages or features of this invention, at least an example of preferred embodiment will be elucidated below with reference to the annexed drawings.

### BRIEF DESCRIPTION OF THE DRAWINGS

The related drawings in connection with the detailed description of this invention, which is to be made later, are described briefly as follows, in which:

FIG. 1 is a schematic view of this invention in three dimensions;

FIG. 2 is a cutaway sectional view of this invention; and

FIG. 3 is a perspective view of this invention when operating.

### DETAILED DESCRIPTION OF THE INVENTION

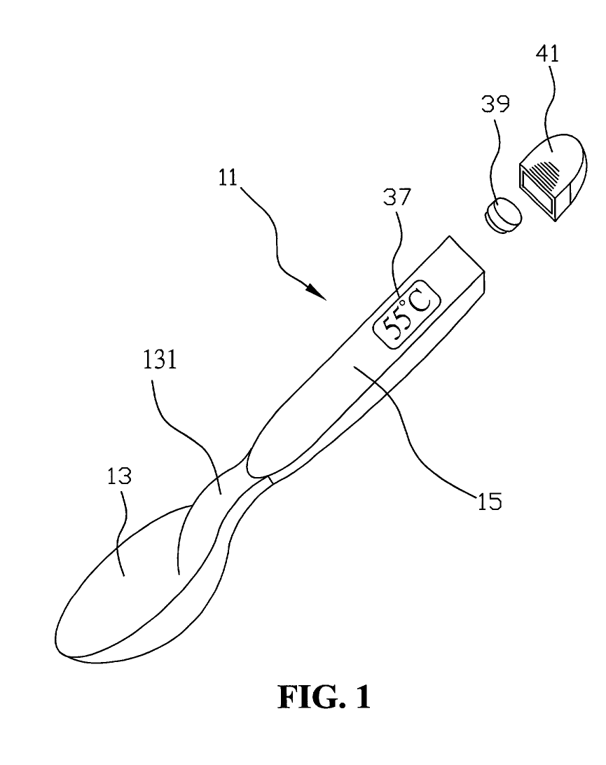

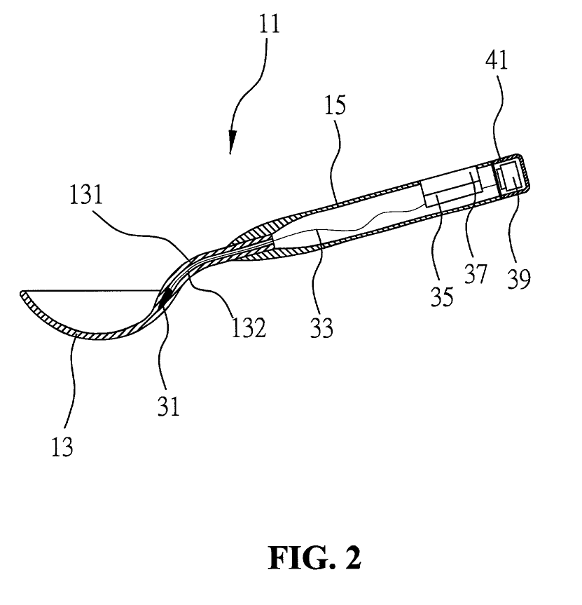

As illustrated in FIGS. 1 and 2, a spoon of this invention comprises a spoon body 11, a thermistor 31, a lead wire 33, a temperature detector 35, a temperature display panel 37, a cell 39, and a cell cover 41.

The spoon body 11 further comprises a spoon handle 15 and a spoon bowl 13, wherein the spoon bowl 13 is made of a heat-conductive metallic material and a spoon neck 131 thereof is a hollow channel. The thermistor 31 is attached to a metallic front edge 132 of the spoon neck 131 and one end of the lead wire 33 is laid along the spoon neck 131 to reach the thermistor 31 while the other is extended inside the spoon handle 15 to connect with the temperature detector 35 internally so that no element will expose to the air to pollute soup or food. The cell 39 is disposed in a hollow tail end of the spoon handle 15 for supplying power to the temperature detector 35 and the temperature display panel 37 and is sealed with the cell cover 41, wherein the temperature display panel 37 is inserted in the spoon handle 15.

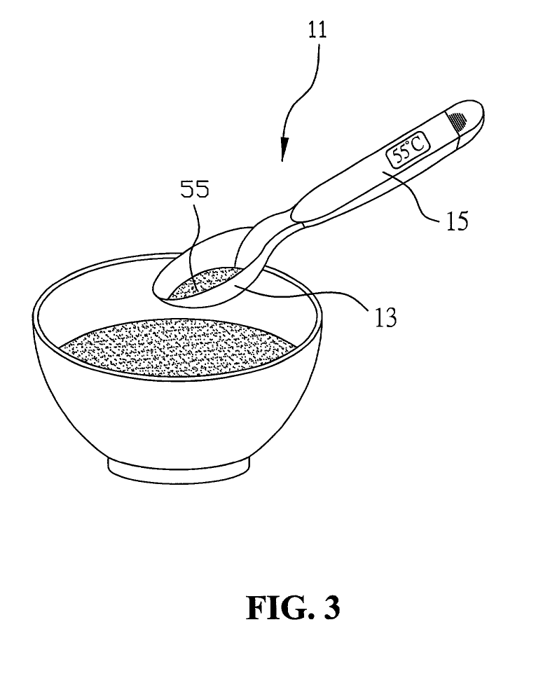

Referring to FIG. 3, when a user holds a spoon of this invention for filling food 55, the impedance of the thermistor 31 is changed because of heat conduction from the food to the spoon bowl 13. Temperature of the food 55 is then detected and converted by the temperature detector 35 into digits and shown in the temperature display panel 37 to keep the user informed of the food's temperature in order not to be scalded.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A spoon with temperature display, comprising a spoon body, a thermistor, a lead wire, a temperature detector, a temperature display, a cell, and a cell cover, wherein the spoon body further comprises a spoon handle and a spoon bowl, wherein the spoon bowl is made of a heat-conductive metallic material and a spoon neck thereof is a hollow channel; the thermistor is attached to a metallic front edge of the spoon neck and one end of the lead wire is laid along the spoon neck to reach the thermistor while the other is extended inside the spoon handle to connect with the temperature detector internally; the cell is disposed in a hollow tail end of the spoon handle for supplying power; and when a user holds such a spoon for filling food, the impedance of the thermistor is changed because of heat conduction from the food to the spoon bowl, so that temperature of the food is detected and converted by the temperature detector into digits and shown in a temperature display panel, which is inserted in the spoon handle.
